(19) United States
(12) Patent Application Publication
(10) Pub. No.: US 2012/0112533 A1
(43) Pub. Date: May 10, 2012

(54) POWER SUPPLY SYSTEM FOR HYBRID VEHICLE

(75) Inventors: Terrance Lee Yarmak, Howell, MI (US); Gary Whelan, Canton, MI (US); Larry Lee Aho, South Lyon, MI (US)

(73) Assignee: Hitachi Automotive Products (USA), Inc.

(21) Appl. No.: 12/942,428

(22) Filed: Nov. 9, 2010

(51) Int. Cl. B60L 1/00

(52) U.S. Cl. 307/10.1; 903/907

(57) ABSTRACT

A power supply system for a hybrid automotive vehicle having a battery which produces a first high voltage sufficient to power one or more electric motors to propel the vehicle. A first voltage step down circuit is connected to the battery circuit which reduces the first voltage to a second voltage sufficient to actuate fuel injectors in the internal combustion engine also used to propel the vehicle. A second step down voltage circuit is connected to either the battery circuit or the first voltage step down circuit which reduces the voltage to a third voltage sufficient to power a low voltage electrically powered device in the drive system of a vehicle.

### BACKGROUND OF THE INVENTION

I. Field of the Invention

The present invention relates generally to power supply systems and, more particularly, to a power supply system for hybrid automotive vehicles.

II. Description of Related Art

Hybrid automotive vehicles, i.e. vehicles having both one or more electric motors as well as an internal combustion engine to propel the vehicle, have enjoyed increased popularity in recent years. This increased popularity is due in large part to the fuel economy enjoyed by hybrid automotive vehicles as contrasted with vehicles driven entirely by internal combustion chamber engines.

Conventionally, both the electric motor system and the internal combustion engine system of a hybrid vehicle maintained their own separate power supplies. For example, in order to power the electric motors used to propel the vehicle, typically the hybrid vehicle contains a high voltage battery which is connected by a battery circuit to a DC-AC converter. The output from the DC to AC converter is then used to propel one or more electric motors to propel the vehicle. In such a configuration, the voltage of the battery oftentimes exceeds hundreds of volts.

Conversely, typically a 12 volt battery is used to power the propulsion system for an internal combustion engine. Essentially all internal combustion engines utilize fuel injection to supply fuel to the engine under the control from an electronic control unit (ECU) for the vehicle. Conventionally, 65 volts is used to actuate or open the fuel injector.

Consequently, in order to obtain 65 volts from the 12 volt battery used to power the internal combustion engine, the power supply system requires an internal circuit to boost the voltage from 12 volts up to 65 volts. Such power boost circuits run under the control of the engine control unit (ECU).

The 12 volt battery is also used to power the fuel pump in the drive system for the vehicle. Additionally, other components of the electric vehicle, e.g. lighting, infotainment units, etc., are also powered by the 12 volt battery.

A primary disadvantage of this previously known power supply system for the internal combustion engine is that the ECU must boost the voltage from 12 volts up to 65 volts in order to actuate the fuel injectors. This creates a great deal of power consumption inside the ECU as well as other expensive components necessary to regulate the voltage in the voltage boost circuit. The ECU is also subjected to many transient voltages generated by the boost circuit for the fuel injectors and, as such, must be of a robust construction as well as having other circuit components also constructed in a robust fashion. This, in turn, increases the overall cost of the power supply system for the internal combustion engine.

### SUMMARY OF THE PRESENT INVENTION

The present invention overcomes the above-mentioned disadvantages of the power supply systems for hybrid vehicles by combining the power supply systems for both the electric motor as well as the internal combustion engine thus eliminating the previously required voltage boost circuits for the internal combustion engine.

In brief, the present invention comprises a battery circuit having a battery which produces a first high voltage sufficient to power one or more electric motors used to propel the motor vehicle. Typically, the battery circuit generates an output voltage of several hundred volts.

A first voltage step down circuit is then connected to the battery which reduces the voltage of the battery to a second lower voltage sufficient to actuate the fuel injectors of the internal combustion engine. Typically, the second voltage is substantially 65 volts.

Similarly, a second voltage step down circuit is also connected to the battery to reduce the output voltage to a third voltage, typically 12 volts, necessary to power the high pressure fuel pump in the vehicle drive system. A still further optional voltage step down circuit may also be employed to produce a second low voltage, i.e. 12 volt, output necessary to power the other electrical devices unassociated with the vehicle drive system. Such devices will include vehicle lighting, infotainment systems, windshield fluid pumps, etc.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a block diagrammatic view illustrating a preferred embodiment of the present invention; and

FIG. 2 is a fragmentary schematic view illustrating a portion of the preferred embodiment of the present invention.

### DETAILED DESCRIPTION OF A PREFERRED EMBODIMENT OF THE PRESENT INVENTION

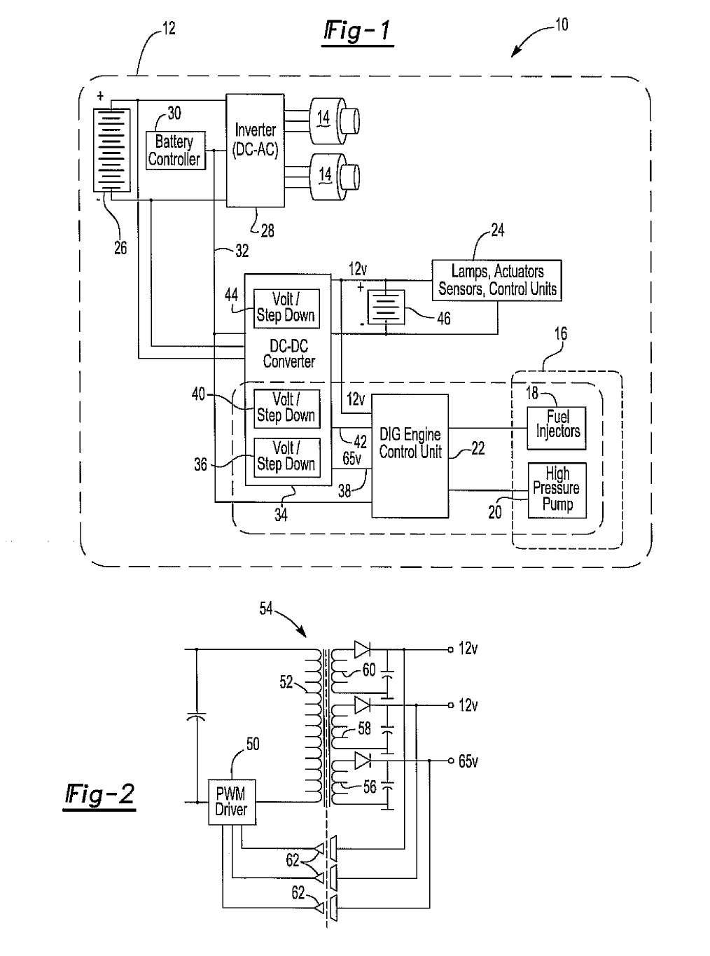

With reference first to FIG. 1, FIG. 1 is a block diagrammatic view illustrating a preferred embodiment of the power supply system 10 for a hybrid automotive vehicle 12, illustrated only diagrammatically. In the well-known fashion, the vehicle 12 includes one or more electric motors 14 to propel the vehicle. Conventionally, these electric motors 14 are alternating current (AC) electric motors.

In addition to the electric motors 14, the hybrid vehicle 12 includes an internal combustion engine 16, illustrated only diagrammatically, which is also used to propel the vehicle 12. The internal combustion engine 16 and motor 14 may operate in a mutually exclusive fashion, or may operate in conjunction with each other depending upon the driving conditions.

Still referring to FIG. 1, the internal combustion engine 16 includes a plurality of fuel injectors 18 as well as a high pressure fuel pump 20 as a part of the vehicle drive system. A relatively high voltage, typically about 65 volts, is necessary to properly actuate the fuel injectors 18 under the control of an engine control unit (ECU) 22. A still lower voltage, typically 12 volts, is necessary to power the fuel pump 20.

The hybrid vehicle 12 also includes a number of other electrically powered devices 24 which do not form part of the engine drive system. These other electrical devices include, for example, interior lighting, headlamps, sensors, actuators, infotainment units, etc. Conventionally, these other electrically powered units require a 12 volt power source.

The power system for the hybrid vehicle includes a high voltage battery 26 with a voltage sufficient to operate the electric motors 14. Typically, the high voltage battery 26 has a voltage of several hundred volts and is electrically connected through a DC-AC inverter 28 to the electric motors 14 to power the motors 14 and propel the vehicle 12. A battery controller 30 controls the operation of the inverter 28, preferably through a network bus such as a CAN network 32. The CAN network 32 couples the devices, such as battery controller 30, inverter 28, DC-DC converter 34, ECU 22, so that the devices could communicate with each other.

Still referring to FIG. 1, the high voltage battery 26 is also coupled as an input to a DC-DC converter 34. This DC-DC converter 34 includes a first voltage step down circuit 36 which reduces the voltage of the high voltage battery 26 to a voltage sufficient to operate the fuel injectors 18, i.e. about 65 volts. This voltage signal is electrically connected on an output line 38 to the fuel injectors 18 under control of the ECU 22.

A second voltage step down unit 40 reduces the battery voltage from the high voltage battery 26 to a voltage sufficient to power the high pressure fuel pump 20, i.e. typically 12 volts. This 12 volt power supply is provided on an output 42 from the DC-DC converter to the fuel pump 20 under the control of the ECU.

Optionally, a third voltage step down circuit 44 is also contained in the DC-DC converter which reduces the voltage from the high voltage battery 26 to a voltage, typically 12 volts, necessary to run other electrical components of the hybrid vehicle 12 that are not associated with the vehicle drive system. These other electrical components include the lamps, actuators, sensors, control units, vehicle clock, etc. as shown at 24. A 12 volt battery 46 of the type commonly found in automotive vehicles with internal combustion engines is also optionally connected to the third voltage step down circuit 44. This battery 46 is also used to drive the electrical components 24, for example when the internal combustion engine 16 and motors 14 are in a shut down condition.

With reference now to FIG. 2, an exemplary DC-DC converter 34 is illustrated in greater detail. As shown, the voltage of the input of the converter 34 is connected in series with a primary coil 52 of a transformer 54. A first output tab 56 provides the 65 volts to run the fuel injectors 18. Similarly, a second output tab 58 provides the 12 volt supply to power the fuel pump 20 while a third tab 60 optionally provides a third 12 volt signal to power the components 24 unassociated with the drive system of the vehicle. Each output, furthermore, may include feedback lines, which are fed to a pulse width modulation (PWM) driver 50 to control the smoothness of the waveform. Each feedback line includes an isolation barrier 62 to prevent the noise on the output voltage to propagate to the PWM driver 50 and to prevent interference of high surcharge caused from the transformer 54.

In the event that the 65 volt output from the DC-DC converter 34 is lost, the ECU 22 sends a fault message along the network 32 to the DC-DC converter. The converter 34 then changes the reference of the 12 volt output 42 to a 65 volt output electrically connected to the fuel injector in order to enable a limp home function for the vehicle.

From the foregoing, it can be seen that the power supply system of the present invention effectively eliminates the voltage boost circuits of the previously known power systems for the internal combustion engine necessary to power the fuel injector 18. This, in turn, eliminates not only the cost of the voltage boost circuitry for the fuel injectors 18, but also the transient voltages generated by such previously known voltage boost circuitry.

The elimination of the voltage transients from the voltage boost circuitry further eliminates, or at least reduces, the cost of transient voltage protection for the 12 volt battery output circuit used to power the devices 24. This, in turn, reduces the size of the power devices, including ASICs and FETs, in the ECU 22. Reduction of the breakdown voltage and size of the power devices not only reduces the cost of those devices, but also the power consumption and resulting heat generation of the ECU 22 as well as the size of the ECU 22.

Having described our invention, many modifications thereto will become apparent to those skilled in the art to which it pertains without deviation from the spirit of the invention as defined by the scope of the appended claims.

We claim:

1. A power supply system for a hybrid automotive vehicle having a drive system with both an electric motor and internal combustion engine with fuel injectors to propel the vehicle, said system comprising:
a battery circuit which produces a first voltage sufficient to power the electric motor,
a first voltage step down circuit connected to said battery circuit which reduces said first voltage to a second voltage sufficient to actuate the fuel injectors,
a second voltage step down circuit connected to said battery circuit which reduces said first voltage to a third voltage sufficient to power a low voltage electrically powered device in the drive system of the vehicle.

2. The power supply system as defined in claim 1 wherein said second voltage is about 65 volts.

3. The power supply system as defined in claim 1 wherein said third voltage is about 12 volts.

4. The power supply system as defined in claim 1 wherein said first voltage step down circuit comprises a DC-DC voltage converter.

5. The power supply system as defined in claim 1 wherein said second voltage step down circuit comprises a DC-DC voltage converter.

6. The power supply system as defined in claim 1 wherein the low voltage electrically powered device comprises a fuel pump.

7. The power supply system as defined in claim 1 wherein an engine control unit selectively connects the output voltages from said first and second step down circuits to the fuel injectors and low voltage electrically powered device.

8. The power supply system as defined in claim 7 wherein said engine control unit is programmed to switch the output voltage of said second voltage step down circuit to said second voltage in the event of failure of said first voltage step down unit.

9. The power supply system as defined in claim 1 and comprising a third voltage step down circuit connected to one of said battery circuit or said first voltage step down unit which reduces one of said first and second voltages to a third voltage sufficient to power electrically powered devices in the vehicle not associated with a vehicle drive system.
